(19) United States
(12) Patent Application Publication
(10) Pub. No.: US 2005/0183055 A1
(43) Pub. Date: Aug. 18, 2005

(54) Method and apparatus for automating the design of programmable logic devices

(75) Inventor: Alfredo Herrera, Ottawa (CA)

Correspondence Address: JOHN C. GORECKI, ESQ., 180 HEMLOCK HILL ROAD, CARLISLE, MA, 01741, US

(73) Assignee: Nortel Networks Limited, St. Laurent (CA)

(21) Appl. No.: 10/771,596

(22) Filed: Feb. 4, 2004

(51) Int. Cl. G06F 17/50

(52) U.S. Cl. 716/17; 716/12; 716/16

(57) ABSTRACT

The design of programmable logic devices, such as FPGAs, may be automated to allow scripts, setup files, and other tool files to be created directly from hollowed and filled netlist, and data-path and design constraint files without extensive human intervention. This allows an FPGA design to be created directly from a logic file to accelerate the FPGA design process. Once hollowed and filled netlists, and data-path and design constraint files have been generated from a design in a standard fashion, the implementation of that design onto an FPGA in an optimized fashion is automated by providing a computer program that is capable of implementing the design, testing the design, evaluating the test results, and altering the design to arrive at a more optimal design. The process may include several steps, such as initial placement of logic groups, sizing of logic groups and FPGA selection, timing analysis, and filled netlist complete design review. The steps may be iterative.

### BACKGROUND OF THE INVENTION

1. Field of the Invention

The present invention relates to very large-scale integration (VLSI) circuit design and, more particularly, to a method and apparatus for automating the design of programmable logic devices.

2. Description of the Related Art

Programmable Logic Devices are general purpose chips that may be configured for a wide variety of applications. Design implementation into a PLD device is done by programming the interconnection of its basic elements to perform the logic functions that embody the design.

There are also many types of basic elements that may be included in a PLD. Several basic elements may be configured to enable conventional logic gates, such as AND gates or OR gates; while other PLD basic elements may be configured as memory elements, such as FIFOs or registers. Other configurations may exist as well and the invention is not limited to a particular type of PLD configuration.

Field Programmable Gate Arrays (FPGAs) are one type of PLD which have obtained widespread use. FPGAs are generally relatively large PLDs that provide the benefits of custom Application Specific Integrated Circuits (ASICs) without incurring the up front costs associated with creating a detailed physical layout of the design required to fabricate a custom ASIC. Additionally, FPGAs are able to be reprogrammed if it becomes necessary to upgrade the electronic device in which the FPGA has been deployed.

FIG. 1 illustrates a functional block diagram of an example FPGA 10. There are many types of FPGAs and the invention is not limited to programming an FPGA such as the example illustrated in FIG. 1. In the example illustrated in FIG. 1, the FPGA 10 includes programmable logic groups 12, programmable input/output blocks 14, programmable interconnects 16, and internal signal lines 18. The logic groups 12, input/output blocks 14, and interconnects 16 may each contain one or more memory elements and/or logic elements to enable the operation of blocks to be controlled. For example, in the FPGA of FIG. 1, the input output blocks 14 are configured to provide a interface between the pins 20 and the internal signal lines 18. These blocks 14 may thus be programmed to selectively connect the pins to one or more of the internal signal lines. The programmable interconnects 16 may be programmed to interconnect internal signal lines within the FPGA to route signals within the FPGA. Additionally, the configurable logic groups 12 may be configured to perform logic operations on signals received on the internal signal lines and to generate signals based on the operation of the FPGA. By supplying an appropriate program, the FPGA may be configured to perform a particular function or set of functions in a network element or other electronic device.

FPGAs may be used in many types of electronic equipment. For example, in the telephony area, FPGAs are used in devices such as telephones, routers, switches, and many other types of network elements. Traditionally, however, FPGAs have been relatively small and able to perform limited functionality. As FPGAs have increased in size and complexity, they have become able to perform increasingly complex functions; they are starting to replace traditional ASICs and other circuit specific hardware.

FIG. 2 illustrates a practical example of an FPGA design implemented in a telephone. While the use of an FPGA in a telephone will be described herein to provide an example that may be useful to understand the methods and techniques associated with the invention, the invention is not limited to designing FPGAs for telephones or other telephony applications.

The example shown in FIG. 2, has a keypad 30, a series of function keys 32, a speaker and microphone section 34, and optionally an LCD 36 that allows textual based information to be displayed to the user. Internally, the phone may contain an electronic circuit which, in this embodiment, has an FPGA 10 configured to enable the various components of the telephone to operate together. Optionally, a memory and microprocessor 38 may also be added to the telephone to provide added functionality. This added functionally is enabled when the memory presence is detected by the FPGA.

For illustration purposes, the different functions of the telephone are shown as logic groups. In the embodiment illustrated in FIG. 2, logic group A has been configured to implement logic associated with supporting the speaker and microphone features 34 of the telephone, logic group B has been configured to implement logic associated with supporting the LCD 36, logic group C has been configured to support and interface with the memory 38, and logic group D has been configured to implement logic associated with supporting the keypad 30 and function keys 32. Other group areas may be implemented as well, such as a logic group to handle communications over one or more telephone lines. Thus, the internal basic elements of the FPGA may be assigned to the logic groups that must all work together to enable the electronic device to function as a telephone.

As FPGAs have increased in size and capability, the ease to program them and the design process associated with optimizing a design on an FPGA has increased in complexity and design effort. FPGA programming typically follows a four step process. Initially, the functionality to be programmed into the FPGA is described in Register Transfer Language (RTL) using either a schematic digital design editor or a Hardware Description Language (HDL) editor. These RTL source files are then synthesized into a representation of the design made of interconnection of logic elements. The result of the synthesis process is referred to as a “netlist”. Also, the design specification is expressed as design constraints to be used in subsequent steps of the implementation process to verify its compliance to the design intent. Persons skilled in the art will recognize that an FPGA design embodiment may include more than one netlist, such as Intellectual Property (IP) core netlists and Logic Function macro netlists. All such embodiments are intended to fall within the scope of the present invention. For clarity purposes, a single netlist will be used in the example used as to not obscure the invention.

Once the netlist is created, it must be transferred to the FPGA. Conventionally, this is done by first mapping the design to the FPGA resources. The mapped logic elements may be grouped in logic groups A-D described above in connection with FIG. 2. These logic groups are then arranged or placed at specific locations on the FPGA. A third step selects routes on the FPGA to interconnect the logic groups. Once this is completed, the placed and routed design is tested to see if it complies with the design constraints. If not, the process iterates and the source files or constraints are adjusted until the process results in a design that passes the requisite tests.

The iterative process requires a human operator to review the test results and, using experience and insight into the design process, to determine how the source files may be altered to produce a more optimal design. For example, if there is a timing problem, the operator may determine that altering placement of the logic components or changing one or more pin allocations on the FPGA would be likely to be able to partially alleviate the timing problem. Using these new design constraints, the process iterates until the new design is able to pass the tests associated with the design. Unfortunately, this process requires considerable time and effort and contributes to the cost and time lag associated with implementing FPGA designs. As FPGAs increase in size, this process only becomes more onerous.

### SUMMARY OF THE INVENTION

The present invention overcomes these and other drawbacks by providing a method and apparatus for automating the design of programmable logic devices. According to one embodiment of the invention, the automated process enables much of the design of programmable logic devices, such as Field Programmable Gate Arrays (FPGAs), to be automated without requiring extensive manual intervention during the iterative process of implementing the design on the FPGA. Accordingly, FPGA design may be accomplished much more quickly and in a more cost-effective manner.

According to an embodiment of the invention, once a netlist has been generated in a standard fashion from a logic design, the implementation of that netlist onto an FPGA in an optimized fashion is automated to arrive at a set of scripts, setup files, etc. The embodiment may proceed through several iterations during the process. For example, in one embodiment of the invention, logic groups associated with the design are first initially placed on an FPGA and sorted to find general placement guidelines that meet the design constraints. Then, once the general placement for the logic groups has been formed, a size estimate is obtained for the logic groups to determine how much of the target device will be used. Once the size and placement have been established, the process will determine whether the proposed placement is likely to pass timing requirements associated with the design. Finally, once the design constraints, timing requirements, and size targets have been satisfied, placed and routed design is tested against a test suite. If everything passes, the design is considered final and the process terminates. This process will be described in greater detail below.

### BRIEF DESCRIPTION OF THE DRAWINGS

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIG. 1 is a functional block diagram of a Field Programmable Gate Array (FPGA);

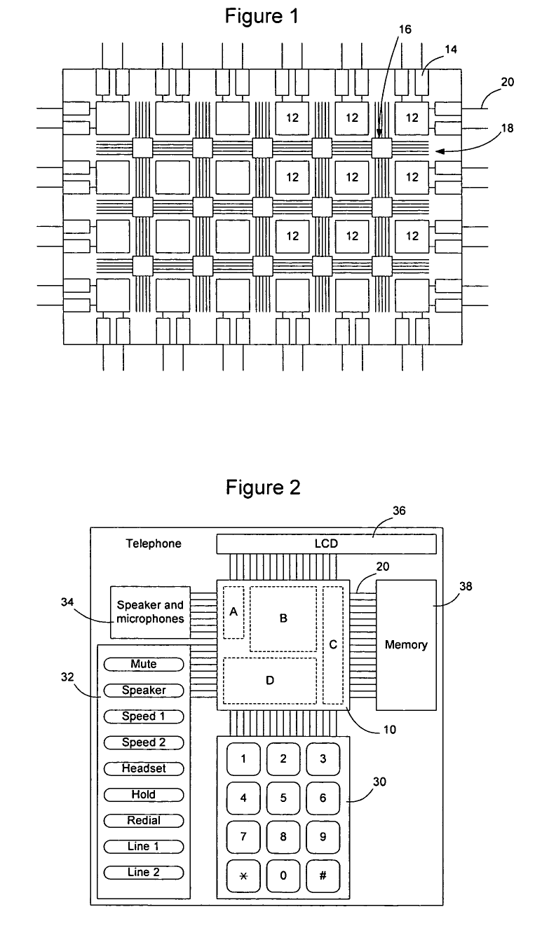

FIG. 2 is a functional block diagram of a telephone incorporating an FPGA such as the FPGA of FIG. 1;

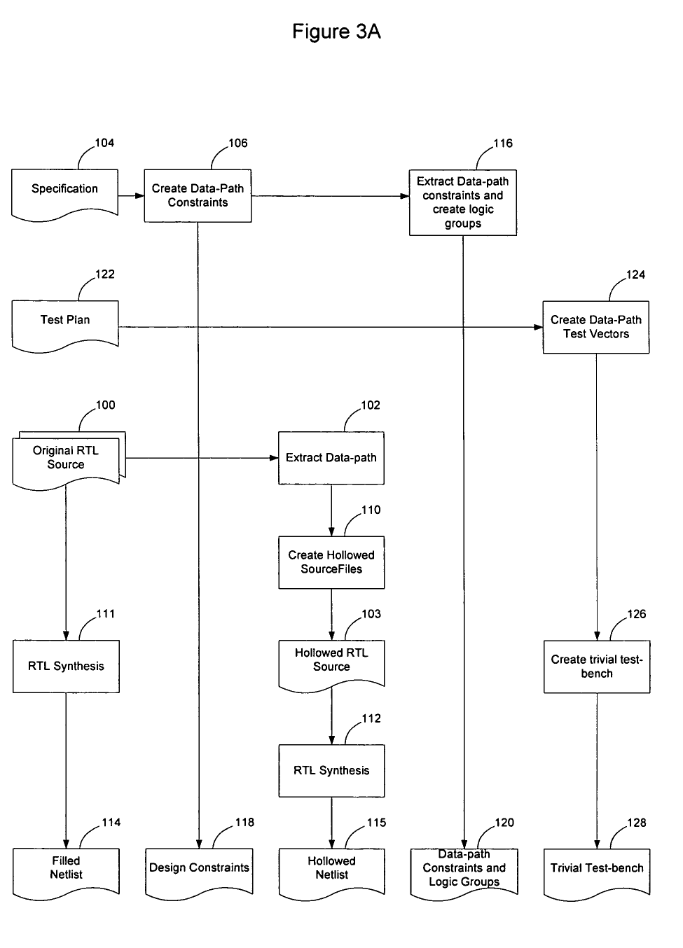

FIGS. 3A and 3B illustrate a process, which may be implemented in software, for automating FPGA design according to an embodiment of the invention;

FIGS. 4A-4F illustrate an example of how logic groups on an FPGA may be altered during the process illustrated in FIGS. 3A-3B; and

FIG. 5 is a functional block diagram of a workstation configured to implement the process illustrated in FIGS. 3A and 3B according to an embodiment of the invention.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

As described in greater detail below, an automated process for designing programmable logic devices, such as Field Programmable Gate Arrays (FPGAs), enables much of the design to be automated without requiring extensive manual intervention during the iterative process of implementing the design on the FPGA. Accordingly, FPGA design may be accomplished much more quickly and in a more cost-effective manner.

According to an embodiment of the invention, once a netlist has been generated in a standard fashion from a logic design, the implementation of that netlist onto an FPGA in an optimized fashion is automated to arrive at a set of scripts, setup files, etc. The embodiment may proceed through several iterations during the process. For example, in one embodiment of the invention, logic groups associated with the design are first initially placed on an FPGA and sorted to find general placement guidelines that meet the design constraints. Then, once the general placement for the logic groups has been formed, a size estimate is obtained for the logic groups to determine how much of the target device will be used. Once the size and placement have been established, the process will determine whether the proposed placement is likely to pass timing requirements associated with the design. Finally, once the design constraints, timing requirements, and size targets have been satisfied, placed and routed design is tested against a test suite. If everything passes, the design is considered final and the process terminates. This process will be described in greater detail below.

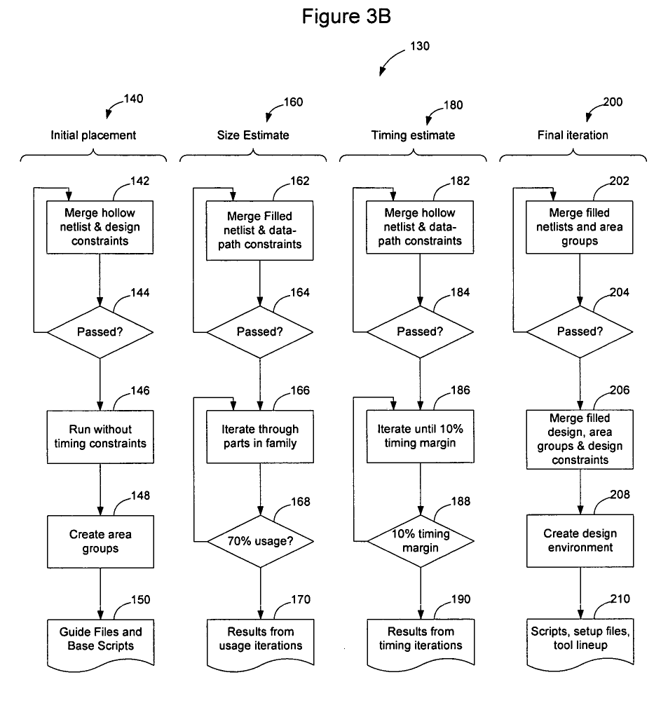

FIGS. 3A and 3B illustrate an embodiment of the invention in which source files are merged into a design for placement on a FPGA. The source files, in this embodiment, encompass the actual design such as the modes of the device, the pins, and the logic, that will be implemented in the FPGA once the design layout is completed. In FIGS. 3A and 3B, FIG. 3A illustrates an example of one way of obtaining a set of design files, such as a filled netlist, a hollowed netlist, a design constraints, and a data-path constraints. The netlist and constraint sets are defined by the physical structure of the FPGA and the logic to be implemented in it. The invention, one example of which is illustrated in FIG. 3B, takes this information and transforms it into a program that may be actually used and downloaded to an FPGA.

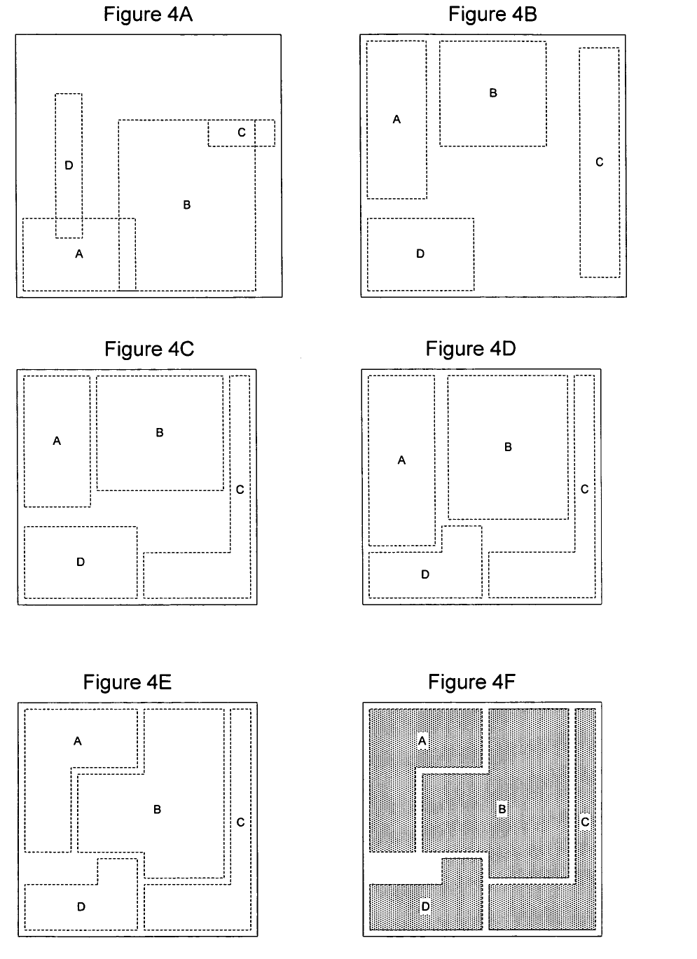

The following description will also refer to FIGS. 4A-4F. These Figs. illustrate one example FPGA containing several logic groups, and are provided to help visualize how the process would be manifest in the design of an actual FPGA. FIGS. 4A-4F are thus not illustrative of the invention, but rather illustrate how the invention might be used to arrive at an optimal design for an FPGA or other programmable logic device.

As shown in FIG. 3A, initially, the source files 100 are operated on to create a hollowed version of the design 103. FIG. 3A also shows that design constraints 118 are extracted 106 from the design specifications 104. The design constraints are operated on 116 to create logic groups and to extract data-path constraints 120. The data-path constraints 120 are the top-level constraints that describe the timing requirements of signals between logic groups, the characteristics of device pins and other types of physical limitations.

By synthesizing 111, 112 the original and hollowed sources 100, 103, two netlists are created: a hollow netlist 115 and a filled netlist 114. The filled netlist 114 contains the full implementation of the design as described in the original source files 100, but the hollowed netlist 115 only contains the boundaries of the defined logical groups with no internal control logic. In a similar way, two sets of constraints are created: data-path constraints 120 and design constraints 118. The design constraints 118 represent the design specifications 104 as originally intended, where the data-path constraints 120 only describe specification for signals between logical groups.

The hollowed netlist 115 is merged with a test plan 122 to create data-path test vectors 124 which are used to create a trivial test-bench 126. The test bench 126 is stored as a trivial test bench file 128 which will be used subsequently to test the overall design once it has been implemented on the FPGA.

Although FIG. 3A has been described in some detail to explain one possible method of obtaining a set of hollow netlists 102 (extracted from the original source files), filled netlists 114 (created by the RTL synthesis), constraints (such as the data-path constraint file 118 and design constraint file 120), and test environment 128, the invention is not limited to this described environment as numerous other environments may be used to create these files as well. Thus, the invention is not limited to this embodiment as the invention may be used in many different forms to merge the information obtained during this or a similar process to completion of an FPGA design.

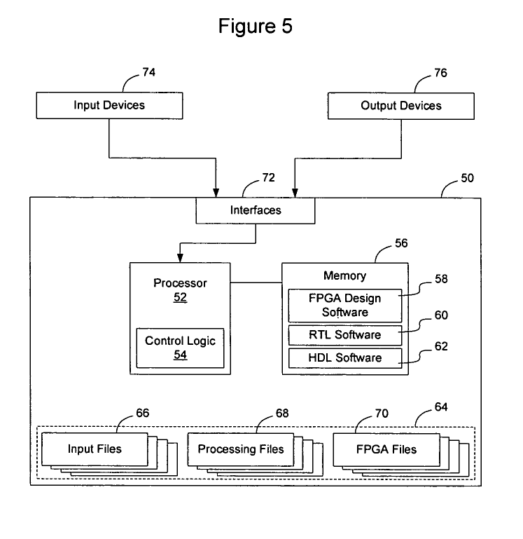

FIG. 3B illustrates one way of taking the information obtained from the process illustrated in FIG. 3A or another process of the same ilk, and converting that information into a usable FPGA design. This process 130 may be implemented in software, hardware, firmware, or in any other manner. In the following description, the process 130 will be described as being performed in a software environment on a computer or other processing platform, such as the processing platform illustrated in FIG. 5. The invention is not limited to this embodiment, however, as other manners of implementing the process may be possible as well.

As shown in FIG. 3B, the software includes several different stages, which are configured to perform different functions in the automated FPGA design process. The first stage, referred to herein as “initial placement 140” is configured to perform initial placement of the logic groups on the FPGA. This enables the logic groups to be placed on the FPGA without worrying about their size, and without consideration as to whether this placement will satisfy the timing requirements. Having a preliminary placement is advantageous in that the logic groups may be sorted out and arranged to be close to the pins that they will control, and to be close to other logic groups with which they will frequently interact.

In one embodiment, the initial placement (also referred to herein as architectural analysis) is performed in the software by using the hollow netlists and the data-path constraints to see if the initial iteration can be executed without any errors, and to see if the design constraints syntax is correct. If the FPGA does not pass using the initial placement, the input files are altered and re-tested until an initial placement on the FPGA is obtained. During this process, timing constraints are ignored and logic groups are mapped. By using a hollow netlist instead of a filled netlist, the initial placement may be performed rapidly since the files being manipulated are relatively small.

FIG. 4A shows an example of initial placement of the logic groups on the FPGA. As shown in FIG. 4A, initially logic groups are arbitrarily sized and placed onto the FPGA so that there is a starting point at which the automated FPGA design process may begin. The logic groups are rearranged during the initial placement process as shown in FIG. 4B. This stage may also determine initial shapes of the logic groups, although the invention is not limited in this manner.

As shown in FIG. 3B, one way of performing the initial placement process is to combine the hollow netlists and design constraints 142. This combination is then checked to see if it passes 144, i.e., if the constraints specified in the constraints files can be read and there are no errors in the hollowed netlist. If not, the source files are modified and the process iterated until no errors are found.

Once the initial placement has passed, the design is run ignoring timing constraints 146 and area groups are created 148. These area groups are used to create guide files and base scripts 150 that will be used subsequently in the process.

Once there is an initial placement, the next step is to evaluate the size of the logic groups and what specific device should be used to implement the FPGA design. Determining the specific device to be used may involve selecting one of several FPGAs in a family or may involve selecting a device from between different FPGA families. FPGA families are generally produced by a manufacturer with the same basic architecture but with different numbers of basic FPGA elements. Often it is desirable to be able to select the FPGA with the smallest number of basic elements for a given design since that is likely to be the least expensive from a manufacturing standpoint. Determining the size of each logic group in the design, enables an FPGA of an appropriate size to be selected.

FIG. 4B illustrates one example of how sizing the logic groups can affect the design of the FPGA. As shown in FIG. 4B, during the sizing process several of the blocks may increase or decrease in size. Additionally, as shown in FIG. 4C, an FPGA from the FPGA family was selected on which the design may be implemented. This FPGA was of slightly smaller dimension than the FPGA used initially in FIGS. 4A-4B. The relative placement of the logic groups may change in subsequent parts of the automated FPGA design process; however, the initial placement should not be dramatically affected by the resizing of the logic groups within a same family. Optionally, the process may iterate by recursing through the initial placement 140 and size estimate 160 procedures until a design meeting these two criteria is obtained (as shown in FIG. 4D).

According to one embodiment of the invention, as shown in FIG. 3B, the logic group sizes are created by running the filled netlists with the data-path constraints 162 and the result tested 164 to see if the initial logic group sizes were adequate and/or optimal given the filled netlists and data-path constraints. For example, one of the initial logic group sizes may be too big and another too small. The sizes and shapes may be adjusted until the appropriate sized logic groups are determined.

Once appropriately sized logic groups are obtained, it may be desirable to include a margin of error at this point such that the logic groups should not use more than 70% of the available basic elements on the FPGA. If the number of basic elements used by the logic groups is much higher than 70% of the available basic elements, it may be desirable to use a larger FPGA in the FPGA family. If the number of basic elements is much smaller than 70%, it may be desirable to use a smaller FPGA in the FPGA family. The invention is not limited to a 70% margin as other margin numbers may be used without departing from the invention. For example, one way of selecting the proper FPGA is to iterate the design through parts in the same FPGA family 166 and check to see if the logic groups in the design occupy a target percentage (such as 70%) of the available basic elements for that FPGA family member (168); where the usage value is too far off of the target percentage, another family member may be selected. Ultimately, the specific FPGA device and size estimates will be returned (170) to be used by other parts of the automated FPGA design process.

Once the specific FPGA is selected and the sizes of the logic groups are known, the software performs a timing analysis 180 to ensure the design will meet the timing requirements. In this process, the hollowed netlist is run with the logic groups properly sized and placed on the FPGA, and timing delays are optimized in view of the data-path timing constraints. The hollowed netlist is used at this point, so the reported timings are merely estimates. However, performing a timing estimate may enable the placement, shape, and/or size of the logic groups to be adjusted to enable timing issues to be alleviated. Additionally, by using hollow netlists at this point, the timing estimate may be performed very rapidly. Optionally, where the timing requirements significantly alter the FPGA design, the first three processes (initial placement, size estimation, and timing estimation) may be iterated until an acceptable design is found that satisfies all three processes. Additionally, the shape of the logic groups may be adjusted at this stage to enable the shapes to better utilize the available basic elements on the FPGA.

FIG. 4E illustrates the result of the timing estimate on the logic groups. As shown in FIG. 4E, the timing requirements associated with the design have caused the groups to be moved closer together in some instances, and have changed the shape slightly (for example with respect to logic groups A and B).

According to one embodiment, timing estimate may be performed by combining the hollow netlists, size estimates and data-path constraints and testing 184 to see if the area groups (which may have been rearranged during the size estimation process) still satisfy the data-path timing requirements. If not, the process iterates until it does. Subsequently, the process checks the timing characteristics 186 of the design and iterates until there is an appropriate timing margin 188. Any timing margin may be selected depending on the implementation and the function to which the FPGA will be used. In the example, a 10% to 30% timing margin is suggested, although the invention is not limited to this embodiment.

Finally, once the timing analysis 180 has been completed, final placement 200 is performed and the improved design is tested to see if it performs as expected. Specifically, at this stage, the logic groups have been placed, sized, and adjusted into area groups that meet all constraints. They are now filled and the logic inserted into the area groups, and the final design is tested to see if it operates in accordance with expectations and within margins defined in the test suite (e.g. trivial test bench 128). One example of how the process of filling the area groups may be implemented is illustrated in FIG. 4F.

According to one embodiment of the invention, for example as shown in the embodiment illustrated in FIG. 3B, the filled netlists are merged with the area groups 202 and the design is analyzed to see if it passes 204. If not, the process iterates by altering the placement, size, or other constraints to obtain a completed design. Once the process has completed, the filled design is run with the design constraints 206 and a design environment is created 208. This generates the scripts, setup files, tool lineup files, etc., 210 that will ultimately be used to program the FPGA.

The process described in connection with FIGS. 3A-3B and 4A-4F may be implemented on a general purpose computer or on a specially designed computing platform. FIG. 5 illustrates one embodiment of an FPGA design station configured to perform FPGA design process according to an embodiment of the invention.

As shown in FIG. 5, an FPGA design station 50 includes a processor 52 containing control logic 54. A memory 56 containing data and instructions is provided to enable the control logic to be configured to perform the functions described above with respect to the FPGA design procedure. For example, the memory 56 may contain FPGA design software 58, configured as described above in connection with FIG. 3B and, optionally, as described above in connection with FIG. 3A. Optionally, the FPGA may also contain other conventional software applications configured to implement one or more portions of the FPGA design process, such as RTL software 60 and HDL software 62. The invention is not limited, however, to an embodiment that implements these additional software packages.

One or more data files 64, either stored in memory, stored in a native database, or stored in an external database, may be provided to contain the data associated with one or more FPGA designs. For example, in the embodiment illustrated the FPGA design station has access to files related to input 66, e.g. raw design information, processing files 68, e.g. files generated by the FPGA design station while in the process of generating a final FPGA design, and final FPGA files 70 which encompass the final output from the FPGA design station. The invention is not limited to this embodiment, however, as other types of files may be used as well or instead of those illustrated.

The FPGA design station may be a general purpose computer or may be a computer that has been adopted to specifically design FPGAs. Persons skilled in the art will recognize that general purpose computers and specially designed computer stations generally have many more components than those illustrated in FIG. 5. For example, the FPGA design station 50 may include interfaces 72 configured to interface with input devices 74 and output devices 76 and numerous other internal and external components. These additional details are routine and have been left out so as to not obscure the invention.

The control logic of FIG. 5 may be implemented as a set of program instructions that is stored in computer readable memory within the network element and executed on a microprocessor within the network element. However, it will be apparent to a skilled artisan that all logic described herein can be embodied using discrete components, integrated circuitry such as an Application Specific Integrated Circuit (ASIC), programmable logic used in conjunction with a programmable logic device such as a Field Programmable Gate Array (FPGA) or microprocessor, or any other device including any combination thereof. Programmable logic can be fixed temporarily or permanently in a tangible medium such as a read-only memory chip, a computer memory, a disk, or other storage medium. Programmable logic can also be fixed in a computer data signal embodied in a carrier wave, allowing the programmable logic to be transmitted over an interface such as a computer bus or communication network. All such embodiments are intended to fall within the scope of the present invention.

It should be understood that various changes and modifications of the embodiments shown in the drawings and described in the specification may be made within the spirit and scope of the present invention. For example, while the text of the description herein has focused extensively on FPGAs, the invention is not limited in this manner but rather extends to other programmable logic devices as well. Accordingly, it is intended that all matter contained in the above description and shown in the accompanying drawings be interpreted in an illustrative and not in a limiting sense. The invention is limited only as defined in the following claims and the equivalents thereto.

1. A method of for automating the design of programmable logic devices, the method comprising the steps of:
obtaining design implementation files, and
calculating a set of design output files from the design implementation files without substantial intervention from a human operator.

2. The method of claim 1, wherein the design implementation files comprise a hollowed hollowed netlist, a filled netlist, data-path constraints, and design constraints.

3. The method of claim 1, wherein the design implementation files are not capable of programming the programmable logic device, and wherein the design output files are capable of programming the programmable logic device.

4. The method of claim 1, wherein the step of calculating a set of design output files comprises generating a set of scripts, setup files, and tool lineup files for use in programming the programmable logic devices.

5. The method of claim 1, wherein the step of calculating a set of design output files comprises the steps of initially placing logic groups on the programmable logic device, estimating the resource usage of the logic groups, estimating timing for the placed and sized logic groups, and filling the logic groups with primitive information.

6. The method of claim 5, wherein the design implementation files comprise a hollowed netlist and design constraints, and wherein the step of initially placing logic groups comprises merging the hollowed netlist with the design constraints, and iterating until the placement of the logic groups meets the constraints.

7. The method of claim 6, wherein a result of initially placing logic groups comprises a list of area groups.

8. The method of claim 5, wherein the design implementation files comprise a filled netlist and data-path constraints, and wherein the step of estimating the size resource usage of the logic groups comprises merging the filled netlist and data-path constraints and iterating until the size of the logic groups is resolved.

9. The method of claim 8, further comprising the steps of analyzing the area usage of the programmable logic device and choosing an appropriate programmable logic device based on the usage analysis.

10. The method of claim 7, wherein the step of estimating timing for the placed and sized logic groups comprises merging the hollowed netlist with the data-path constraints, and performing a timing analysis on the merged hollowed netlist and data-path constraints to obtain an acceptable timing margin.

11. The method of claim 7, wherein the step of filling the logic groups with FPGA basic elements comprises merging the filled netlists, design constraints, and area groups, and running the filled design to verify that it will meet design criteria.

12. The method of claim 1, wherein the programmable logic device is a Field Programmable Gate Array.

13. The method of claim 12, wherein the design implementation files are files generated from Hardware Descriptor Language (HDL) files that have been subject to Register Transfer Language (RTL) Synthesis.

14. A computer configured to automate the design of programmable logic devices, comprising:
FPGA design software configured to translate at a file created using at least one of a Hardware Descriptor Language and a Register Transfer Language, into a format usable to program a programmable logic device.

15. The computer of claim 14, wherein the FPGA design software is further configured to iterate the translation to achieve an optimized format.
